(19) United States
(12) Patent Application Publication
(10) Pub. No.: US 2013/0162084 A1
(43) Pub. Date: Jun. 27, 2013

(54) SPINDLE MOTOR

(71) Applicant: SAMSUNG ELECTRO-MECHANICS CO., LTD., SUWON (KR)

(72) Inventor: DONG JIN PARK, SUWON (KR)

(73) Assignee: SAMSUNG ELECTRO-MECHANICS CO., LTD., SUWON (KR)

(21) Appl. No.: 13/716,767

(22) Filed: Dec. 17, 2012

(30) Foreign Application Priority Data
Dec. 27, 2011 (KR) 10-2011-0143603

(51) Int. Cl. H02K 7/08

(52) U.S. Cl. 310/90

(57) ABSTRACT

Disclosed herein is a spindle motor including: a shaft; a sleeve having a hollow cylindrical shape so as to rotatably support the shaft; and a base including a cylindrical support part and having the sleeve inserted into and fixed to a hollow part formed at the center of the support part, wherein the sleeve includes a sleeve upper end portion and a sleeve lower portion. The sleeve includes the sleeve upper end portion and the sleeve lower end portion that are arranged to face each other and includes a thrust plate disposed between the sleeve upper end portion and the sleeve lower end portion.

### CROSS REFERENCE TO RELATED APPLICATION

This application claims the benefit of Korean Patent Application No. 10-2011-0143603, filed on Dec. 27, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

A spindle motor has been widely used as a driving unit for a recording medium of a hard disk drive (HDD), an optical disk drive (ODD), and other recording media requiring high speed rotation.

That is, the spindle motor, which is a device rotating a disk so that data written in the disk may be read using a head, generates a magnetic field when current is applied to a core. This magnetic field provides magnetic force to a magnet provided in a rotor. Then, a motor rotates by an operation principle of rotating the rotor through the magnetic force.

An example of this spindle motor has been disclosed in Patent Document 1.

The spindle motor disclosed in Patent Document 1 is configured to include a stator including a sleeve, a shaft rotatably inserted into the sleeve, and a rotor mounted as a hub at the shaft to rotate together with the shaft, as already well known.

The spindle motor according to the prior art requires separate rotation power in order to rotate the rotor around the stator. To this end, the spindle motor has a structure in which a core having a coil wound therearound faces a magnet mounted on an inner side surface of the rotor. A thrust plate is seated on an upper end portion of the shaft and has the hub coupled to an upper portion thereof. The thrust plate forms a predetermined clearance, that is, an oil gap between the shaft and the sleeve, which is filled with a lubricating fluid such as oil to provide a hydrodynamic bearing. Further, in order to prevent the sleeve and the thrust plate from being separated from each other, a cap should be provided at an upper end of the sleeve.

Since the spindle motor having the above-mentioned structure generally includes a plurality of members seated on the sleeve, the center of gravity thereof cannot but be positioned at an upper end of the entire length part of the shaft. That is, the center of gravity of the spindle motor is positioned at a point of 25% from an upper end of the entire length part of the shaft, which almost coincides with a height at which the thrust plate is seated.

When the center of gravity is raised as described above, the shaft does not stably rotate, and a non repeatable run out (NRRO) defect is caused.

Further, in the spindle motor according to the prior art, when the cap fixing the sleeve and the thrust plate to each other is bonded to the sleeve and the thrust plate as described above, an unexpected axial gap may be generated. Therefore, the cap should be more precisely bonded to the sleeve and the thrust plate.

Therefore, in order to solve the above-mentioned problems, those skilled in the art have urgently demanded other methods for lowering the center of gravity of a spindle motor.

### PRIOR ART DOCUMENT

### Patent Document

(Patent Document 1) Patent Document 1: Korean Patent No. 10-1079480

### SUMMARY OF THE INVENTION

The present invention has been made in an effort to provide a spindle motor capable of lowering the center of gravity thereof by lowering an installation level of a thrust plate.

According to a preferred embodiment of the present invention, there is provided a spindle motor including: a shaft; a sleeve having a hollow cylindrical shape so as to rotatably support the shaft; and a base including a cylindrical support part and having the sleeve inserted into and fixed to a hollow part formed at the center of the support part, wherein the sleeve includes a sleeve upper end portion and a sleeve lower end portion. The sleeve includes the sleeve upper end portion and the sleeve lower end portion that are arranged to face each other and includes a thrust plate disposed between the sleeve upper end portion and the sleeve lower end portion.

The sleeve upper end portion may have the cylindrical shape and include a step part formed at a lower end of an inner peripheral surface thereof, and the sleeve lower end portion may have the cylindrical shape and include a step part formed at an upper end of an inner peripheral surface thereof. That is, in the spindle motor according to the preferred embodiment of the present invention, the sleeve is formed by stacking the sleeve upper end portion and the sleeve lower end portion so as to face each other. Alternatively, since the sleeve upper end portion and the sleeve lower end portion are the same components, divided sleeve members may be used as the sleeve upper end portion and/or the sleeve lower end portion as needed by an operator.

According to the preferred embodiment of the present invention, the thrust plate is installed at a lower height as compared with the prior art in order to lower the center of gravity. To this end, the thrust plate is positioned at an intermediate point of an axial length part of the sleeve rather than an upper portion of the shaft, more specifically, in a space formed by the step parts of the sleeve upper end portion and the sleeve lower end portion that are arranged to face each other.

In addition, according to the preferred embodiment of the present invention, the shaft may include a groove formed in an outer peripheral surface thereof in order to prevent separation between the thrust plate and the shaft. Therefore, a portion of the thrust plate is received in the groove of the shaft; however, a remaining portion of the thrust plate is positioned at a space part of a bonded sleeve.

According to the preferred embodiment of the present invention, the groove of the shaft and the space part of the sleeve may be formed at the same height to ensure horizontality of the thrust plate.

In the spindle motor according to the preferred embodiment of the present invention mounted with the sleeve divided into two parts, the sleeve upper end portion includes journal grooves formed in an inner side surface thereof and thrust grooves formed in a step part thereof in order to provide a hydrodynamic bearing.

According to another preferred embodiment of the present invention, the thrust plate and the shaft are formed integrally with each other. In another preferred embodiment of the present invention, the groove is not formed in the shaft in the preferred embodiment of the present invention, but the thrust plate protruded on an outer peripheral surface of a corresponding axis in a radial direction is provided.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic cross-sectional view of a spindle motor according to a first preferred embodiment of the present invention;

FIG. 2 is a perspective view of a sleeve upper end portion configuring a portion of a sleeve; and

FIG. 3 is a schematic cross-sectional view of a spindle motor according to a second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

FIG. 1 is a schematic cross-sectional view of a spindle motor according to a first preferred embodiment of the present invention.

Referring to FIG. 1, the spindle motor 1 according to the preferred embodiment is configured to include a base 10, a sleeve 20, a shaft 30, a rotor 40, and a stator 50.

The base 10, which is installed in a device such as a hard disk drive (not shown), or the like, provides a space capable of receiving members configuring the spindle motor therein. As shown in FIG. 1, the base 10 includes a cylindrical support part 110 formed at the center thereof, and a sleeve 20 to be described below is inserted into and coupled to a hollow part formed at the center of the support part 110.

In addition, the base 10 includes a pulling plate 120 attached to an upper surface thereof, wherein the pulling plate 120 is made of a magnetic material. Preferably, the pulling plate 120 is disposed at a portion adjacent to a magnet 45 to be described below, such that attractive force by magnetic force acts between the pulling plate 120 and the magnet 45.

The sleeve 20 may be inserted and assembled into the support part 110 of the base 10 as described above. In addition, the sleeve 20 has a generally cylindrical shape to rotatably support the shaft 30 therein.

The sleeve 20 includes a hydrodynamic bearing formed in an inner peripheral surface thereof spaced apart from the shaft 30 by a predetermined interval and a bearing surface thereof contacting a thrust plate 60.

The spindle motor 1 according to the preferred embodiment of the present invention includes the sleeve 20 configured of two parts, more specifically, a sleeve upper end portion 210 and a sleeve lower end portion 220. In other words, the sleeve 20 may be divided into the sleeve upper end portion 210 and the sleeve lower end portion 220 and be fixed by various schemes, for example, a bonding scheme, a laser welding scheme, a press-fitting scheme, or the like.

Preferably, the sleeve upper end portion 210 has the same size and shape as those of the sleeve lower end portion 220. Since the sleeve upper end portion and the sleeve lower end portion have the same shape and size as each other, they need not to be individually manufactured, such that a manufacturing cost and the number of manufacturing processes may be decreased. Here, the sleeve upper end portion and the sleeve lower end portion are individually named only in order to be easily distinguished from each other according to positions at which they are arranged and are members that are the same as each other.

The sleeve upper end portion and the sleeve lower end portion may be arranged in an axial direction so as to face each other, thereby forming the sleeve 20.

In addition, the sleeve 20 includes a concave groove formed in an inner peripheral surface thereof to provide a space capable of receiving the thrust plate 60 therein.

The thrust plate 60 may accomplish the same object as that of the thrust plate of the spindle motor according to the prior art as well known to those skilled in the art and form a hydrodynamic bearing between the sleeve 20 and the shaft 30.

In other words, a step part 211 is formed at the sleeve upper end portion 210 so that the thrust plate 60 may form an oil gap together with the sleeve 20. The step part 211 is formed at a lower end of an inner side surface of the sleeve upper end portion 210, as shown in FIG. 1. In addition, the sleeve lower end portion 220 having the same shape as that of the sleeve upper end portion also includes a step part 221 formed at an upper end of an inner side surface thereof and corresponding to the step part 211 of the sleeve upper end portion 210.

When the sleeve upper end portion 210 and the sleeve lower end portion 220 are arranged to face each other, the step part 211 of the sleeve upper end portion 210 and the step part 221 of the sleeve lower end portion 220 face each other to form an annular groove having a generally concave shape. Therefore, the thrust plate 60 may be positioned between the sleeve upper end portion 210 and the sleeve lower end portion 220 arranged to face each other.

Preferably, the shaft 30 includes a groove 311 formed in an outer peripheral surface thereof. The thrust plate 60 is partially inserted into and fixed to the groove 311, such that it is not separated from the shaft 30 in the axial direction. Since the thrust plate 60 is not separated from the shaft 30 through the sleeve 20, a component such as a cap according to the prior art is not separately required.

The shaft 30 has an upper portion supporting a hub 41 in the axial direction and is inserted into the sleeve 20 to thereby be rotatably supported by the sleeve upper end portion 210 of the sleeve 20, and the thrust plate 60 is arranged at a central portion of the sleeve 20, as described above.

In other words, it is preferable that the shaft 30 is maintained in the state in which it is spaced apart from a surface of the thrust plate 60 as well as the inner peripheral surface of the sleeve 20; 210 and 220 by a predetermined interval not to contact the surface of the thrust plate 40 as well as the inner peripheral surface of the sleeve, in order to decrease contact frictional force with the surface of the thrust plate 60 as well as the inner peripheral surface of the sleeve. In addition, a clearance between the sleeve 20 and the shaft 30, a clearance between the shaft 30 and the thrust plate 60, and a clearance between the sleeve 20 and the thrust plate 60 may be filled with a lubricating fluid, for example, oil, and friction between the sleeve 20 and the thrust plate 60 may be decreased through the oil at the time of rotation of the shaft 30.

Further, the cup shaped rotor 40 includes the hub 41 and a skirt part 42 having the magnet 45 mounted thereon, and the shaft 30 is disposed on a line of a vertical axis coinciding with the center of rotation of the hub 41.

The rotor 40, which is a rotating structure provided to form an electric filed for rotating the hub 41 to thereby be rotatable with respect to the stator 50, includes the ring shaped magnet 45 disposed on an inner peripheral surface of the skirt part 42, wherein the magnet 45 is disposed to face a core 51, having a predetermined interval therebetween, and forms a magnetic field to generate electromagnetic force together with an electric field formed in a coil 52. The rotor 40 of the spindle motor rotates by the electromagnetic force. The hub 41 allows a disk (not shown) to be rotatable in order to record and reproduce a signal.

The stator 50 is a fixed structure including the ring shaped core 51 fixedly disposed on the base 10 and the coil 52 wound around the core 51 to generate the electric field.

As shown in FIG. 1, in the spindle motor 1 according to the preferred embodiment of the present invention, the thrust plate 60 is disposed at an intermediate position of a length part of the shaft 30 or a position lower than the intermediate portion, thereby making it possible to generally lower the center of gravity of the spindle motor 1.

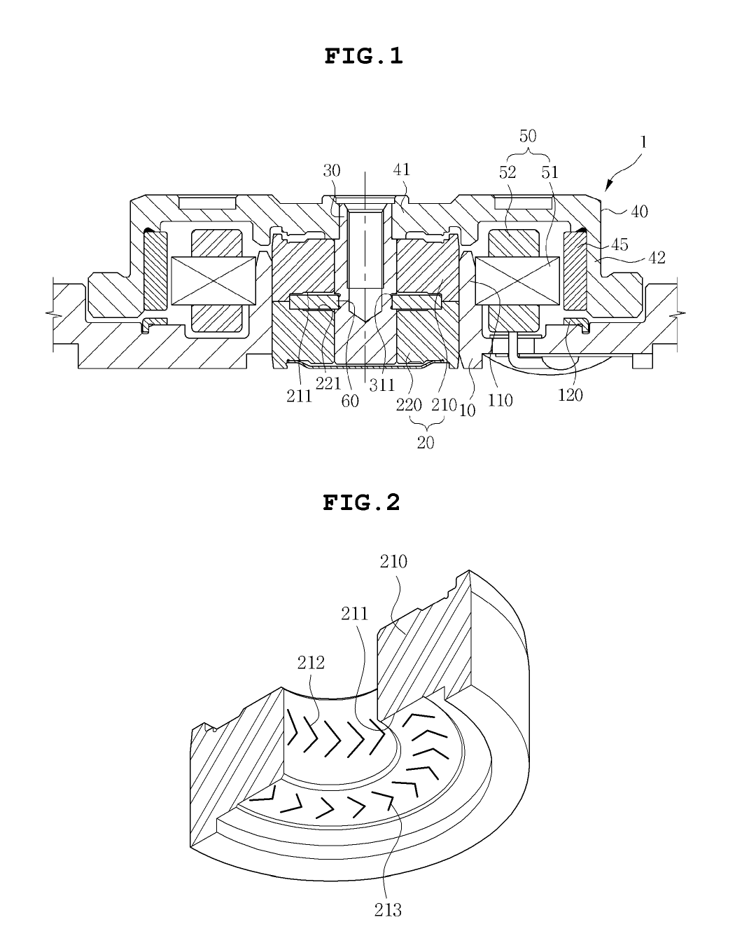

FIG. 2, which is a perspective view of a sleeve upper end portion configuring a portion of a sleeve, is a view of the sleeve upper end portion 210 viewed from the bottom. In addition, since the sleeve lower end portion 220 (See FIG. 1) has the same shape as that of the sleeve upper end portion 210, a detailed description thereof will be omitted. At the time of installation, the sleeve lower end portion may be used by arranging the sleeve upper end portion in the axial direction in an overturned state.

The sleeve upper end portion 210 has a generally cylindrical shape so that it may receive the shaft 30 (See FIG. 1) at the center thereof. In addition, the sleeve upper end portion 210 includes a step part 211 formed along an edge of a lower end of an inner side surface thereof.

The sleeve upper end portion 210 includes journal grooves 212 formed in an inner side surface thereof, more specifically, above the step part 211, and includes thrust grooves 213 formed in the step part 211 thereof, as shown in FIG. 2.

The journal grooves 212 are formed in the inner side surface of the sleeve upper end portion 210 contacting the shaft 30 (See FIG. 1) to generate dynamic pressure in a radial direction, and the thrust grooves 213 are formed in the step part 211 of the sleeve upper end portion 210 contacting an upper surface of the thrust plate 60 (See FIG. 1) to generate dynamic pressure in the axial direction.

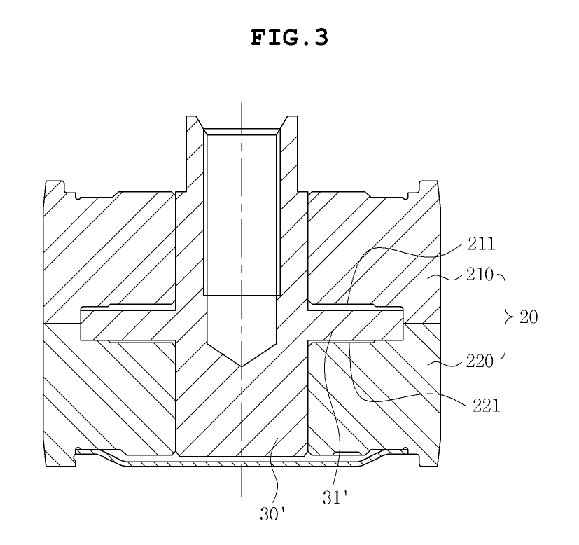

FIG. 3 is a schematic cross-sectional view of a spindle motor according to a second preferred embodiment of the present invention.

The spindle motor according to the second preferred embodiment of the present invention shown in FIG. 3 is similar to the spindle motor 1 shown in FIG. 1 except for a shaft. Therefore, in order to assist in clearly understanding the present invention, a description of components that are the same as or similar to the above-mentioned components will be omitted.

Specially, in the spindle motor according to the second preferred embodiment of the present invention, a shaft 30′ and a thrust plate are formed integrally with each other. That is, the shaft 30′ includes the thrust plate 31′ protruded on a length part thereof in a radial direction perpendicular to a direction in which the shaft 30′ is extended. The shaft 30′ is configured of a single component formed integrally with the thrust plate 31′, thereby making it possible to improve durability as compared with the prior art and exclude a process of coupling the shaft and the thrust plate to each other.

The shaft 30′ includes the thrust plate 31′ inserted into an annular groove formed between the sleeve upper end portion 210 and the sleeve lower end portion 220 arranged in parallel with each other and having a concave shape, such that separation between the shaft 30′ and the sleeve 20 may be prevented, and a clearance between the shaft 30′ and the sleeve 20 may be filled with oil.

As set forth above, according to the preferred embodiment of the present invention, the spindle motor in which an installation level (or height) of the thrust plate is lowered is provided.

According to the preferred embodiment of the present invention, the installation level of the thrust plate seated on the upper end of the shaft according to the prior art is lowered so as to be positioned at the intermediate portion of the shaft to lower the center of gravity of the spindle motor, thereby making it possible to improve mechanical reliability of the spindle motor.

In addition, according to the preferred embodiment of the present invention, since the gap for assisting in seating the thrust plate is not separately provided, a weight, a thickness, a manufacturing cost, and the number of manufacturing processes of the spindle motor may be decreased.

According to the preferred embodiment of the present invention, the sleeve may be divided into the sleeve upper end portion and the sleeve lower end portion, which may be manufactured to have the same structure. According to the preferred embodiment of the present invention, an additional cost is not generated by the sleeve upper end portion and the sleeve lower end portion having the same structure.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft;
a sleeve including a sleeve upper end portion and a sleeve lower end portion that have a hollow cylindrical shape so as to rotatably support the shaft;
a base including a cylindrical support part and having the sleeve inserted into and fixed to a hollow part formed at the center of the support part; and
a thrust plate inserted between a lower portion of the sleeve upper end portion and an upper portion of the sleeve lower end portion.

2. The spindle motor as set forth in claim 1, wherein the sleeve upper end portion has the cylindrical shape and includes a step part formed at a lower end of an inner peripheral surface thereof.

3. The spindle motor as set forth in claim 1, wherein the sleeve lower end portion has the cylindrical shape and includes a step part formed at an upper end of an inner peripheral surface thereof.

4. The spindle motor as set forth in claim 1, wherein the thrust plate is positioned in a space formed by the step parts of the sleeve upper end portion and the sleeve lower end portion that are arranged to face each other.

5. The spindle motor as set forth in claim 1, wherein the shaft includes a groove formed in an outer peripheral surface thereof.

6. The spindle motor as set forth in claim 1, wherein the sleeve upper end portion and the sleeve lower end portion are the same components that have the same size and shape.

7. The spindle motor as set forth in claim 1, wherein a groove of the shaft has the same height as that of a space formed by the sleeve upper end portion and the sleeve lower end portion that are arranged to face each other.

8. The spindle motor as set forth in claim 1, wherein the shaft is formed integrally with the thrust plate.

9. The spindle motor as set forth in claim 1, wherein the sleeve upper end portion includes journal grooves formed in an inner side surface thereof and thrust grooves formed in a step part thereof.
